(19) United States
(12) Patent Application Publication
(10) Pub. No.: US 2002/0179629 A1
(43) Pub. Date: Dec. 5, 2002

(54) Transport system

(76) Inventor: Per Sorensen, Oslo (NO)

Correspondence Address: YOUNG & THOMPSON, 745 SOUTH 23RD STREET 2ND FLOOR, ARLINGTON, VA, 22202

(21) Appl. No.: 10/148,401

(22) PCT Filed: Dec. 1, 2000
(86) PCT No.: PCT/NO00/00406

(30) Foreign Application Priority Data
Dec. 3, 1999 (NO) 19995969

(51) Int. Cl. B65G 59/00; G07F 11/72; A24F 27/14; B65D 83/00; B65H 3/00; B23Q 7/04; G07F 11/16

(52) U.S. Cl. 221/209

(57) ABSTRACT

The invention relates to a transport system for everyday commodities, comprising a supply device which is located, e.g., in a store, a transport arrangement with at least one open or closed transport way and a discharge device which, eg., is located in sales premises. The transport system is characterized in that the transport way comprises at least one of the following units: advertising units, temperature-regulating units, insulating units, storage units, detector units, pure transport units, push/pull units and delivery units.

The present invention relates to a transport system and is a further development of patent application no. PCT/NO99/00184 with the same applicant. The said application concerns a transport system for chilled products, comprising a supply device and a discharge device, where the supply device is located, e.g., in a store and the discharge device is located, e.g., in sales premises, where the system further comprises a transport arrangement with at least one open or closed transport way such as a channel, a duct or the like between the supply device and the discharge device.

The invention is concerned with the transport way in such a system. The aim of the transport system is to permit space saving and flexibility in connection with the delivery of the goods and thus it is vital that the transport ways, which are the most important part of the system, also satisfy these requirements.

From U.S. Pat. No. 5,586,686, e.g., a transport system is known which establishes a connection between a store and sales premises. The transport system described in this publication consists of ducts and mechanical pusher elements which transfer the goods to a discharge device. The ducts are fixed to a ceiling structure and are constructed in one piece. This results in reduced flexibility with regard to replacement of defective parts and positioning of the discharge devices. Nor is the transport system suited for carrying advertisements.

The object of the invention is to counter the above-mentioned and other drawbacks of the known systems by means of a transport way comprising at least one of the following units: advertising units, temperature-regulating units, insulating units, storage units, detector units, pure transport units, push/pull units and delivery units.

In a preferred embodiment of the invention the transport way consists of several units of the same or of different types, which can be assembled to form the way. The units may be screwed together, welded together, be equipped with tongue-and-groove mechanisms or other suitable fastening mechanisms. Several units may be connected “in parallel” in order to provide several parallel ways. They may also be attached in an angular position relative to one another, thereby providing branches. The transport system according to the invention therefore provides great flexibility with regard to the way's length and position and offers the possibility of a variety of positions for the discharge device.

In a further preferred embodiment of the invention the transport system comprises at least one unit which combines several of the above-menitioned units, being equipped, e.g., with temperature-regulating devices and advertising devices. The system permits all possible combinations of units and this will also increase the system's adaptability to several areas of application.

The advertising units may be equipped with different advertising devices, such as, e.g., light sources, including light diodes, parts for providing special effects such as, e.g., misting and sound. The units may also comprise advertisement holders or transparent parts, which display the goods as well as acting as a visual check on the state of the arrangement. It is also envisaged that one and the same advertising unit may comprise several different advertising devices.

The temperature-regulating units preferably comprise transport devices for cooling/heating agents, and in an embodiment of the invention, these transport devices are designed in such a manner that the cooling agents and the goods are not in direct contact with one another. This may be achieved, e.g., by the temperature-regulating units comprising a supporting layer for the commodity together with one or more additional layers at a distance from the supporting layer to enable cold or hot air, water or another fluid to circulate between the transport way and the additional layer or layers.

In another embodiment of the transport system the temperature-regulating units are equipped with means for permitting air, water or another fluid to circulate in contact with the goods. In such a case the fluid can also be used for pushing/pulling the goods along the way.

Another possibility is that the temperature-regulating units comprise a combination of the two above-mentioned embodiments.

In a preferred embodiment of the system according to the invention, the insulating units are equipped with thermal or sound insulation. The thermal insulation will permit a reduction in the number of units with temperature regulation which are required in the transport system, while the sound insulation units will reduce the system's noise level.

In yet another preferred embodiment of the invention the transport way will comprise-storage units. It will hereby comprise a store distributed over the entire distance between the supply and discharge devices. This will be particularly advantageous for use in premises where lack of space is a problem, such as, e.g., in trains or boats. The storage units in turn can be equipped with heating/cooling devices for the goods. This will be particularly useful as it will permit a simple and reasonably priced transport way to be provided where the number of temperature-regulating units is reduced to a minimum, or even none at all. Another possibility is to use temperature-regulating units to keep goods at a temperature which is suitable for storage while the desired delivery temperature for the customer is obtained by means of heating/cooling devices in the vicinity of or integrated in the delivery units.

The detector units preferably comprise means for detecting the presence or passage of the goods, possibly for stocktaking. The detector units may also comprise means for temperature measurement, detection of smoke, steam or ice formation. Thus they will permit a complete check to be made of the state of the system. The detector units may also comprise means for checking the position of the goods in the way, thus ensuring, e.g., that the goods' labels are displayed as conspicuously as possible to the customers.

In a preferred embodiment of the invention, the delivery units comprise a holding mechanism with an external and an internal set of bars, where each set is equipped with arms for securing the item and where the bars permit movement of the arms in the desired direction. The holding mechanism will permit the next product to be passed forward in a controlled manner to the user when a first product is removed from the discharge device.

In a preferred embodiment of the invention, the discharge device comprises a support surface for fluid (cooling, heating or transport fluid) which is passed through the transport system and ensures that the air circulates round the item before it leaves the system. It may also comprise a suction hole or the like for providing underpressure and thereby returning the fluid to the system. This unit may also comprise a lid which closes the transport way when it is empty or when the system is not in use.

The various units may be provided, e.g., in the form of prefabricated ducts/profiles, which are inexpensive to produce. The use of closed ducts leads to a simple and reasonably-priced system, while it may be advantageous to have some units which are open channels for inspection and manual filling/emptying of the system.

The invention will now be described in more detail by means of drawings, in which:

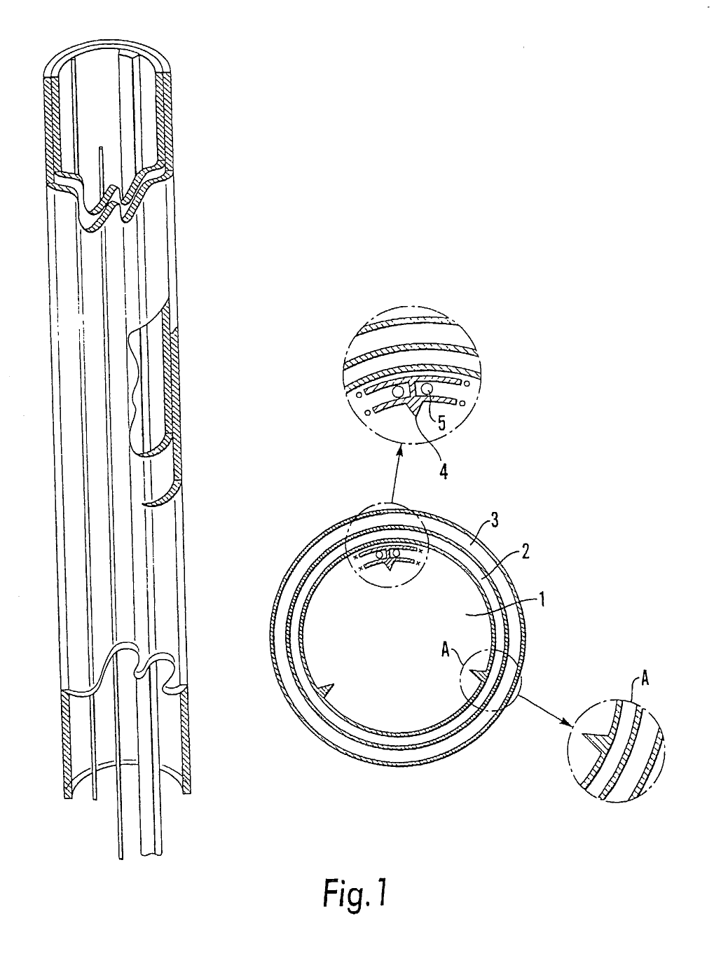

FIG. 1 illustrates a transport way unit according to an embodiment of the invention,

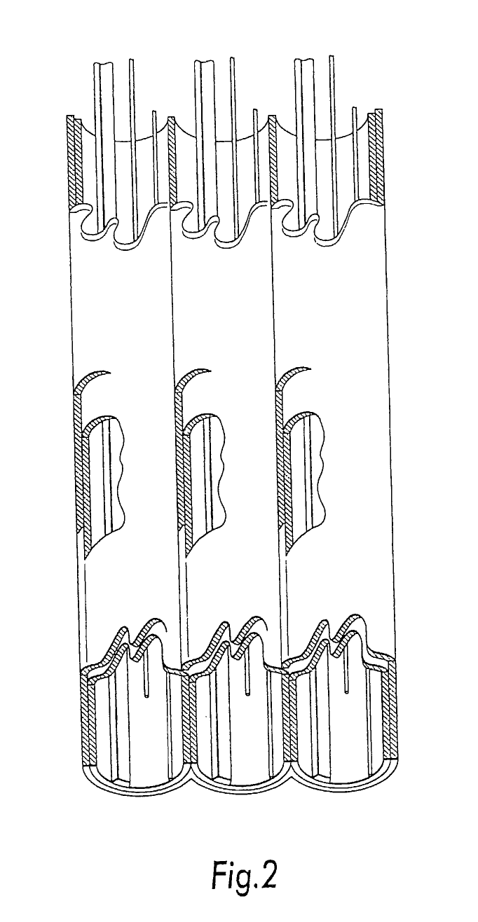

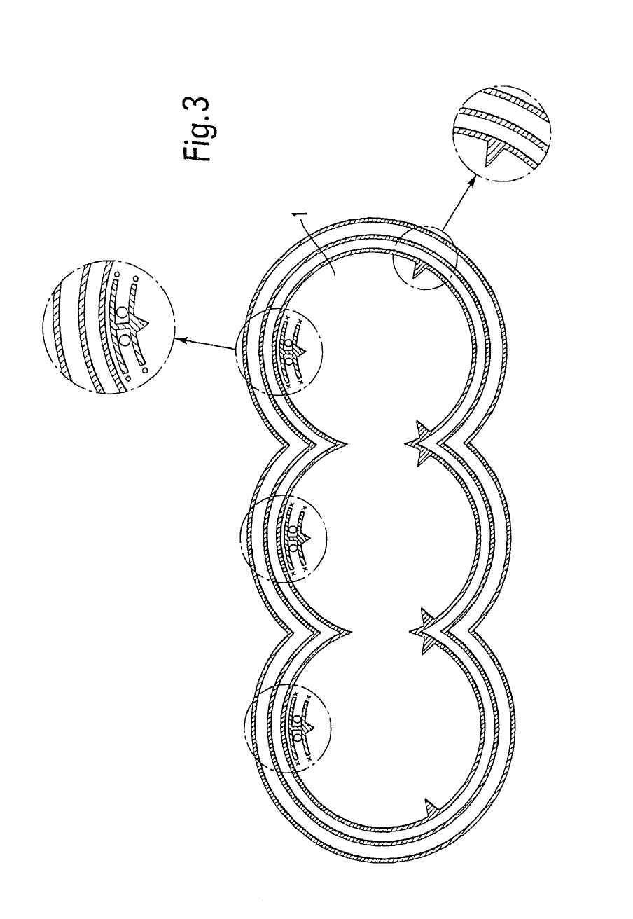

FIGS. 2 and 3 illustrate the arrangement of several units “in parallel”,

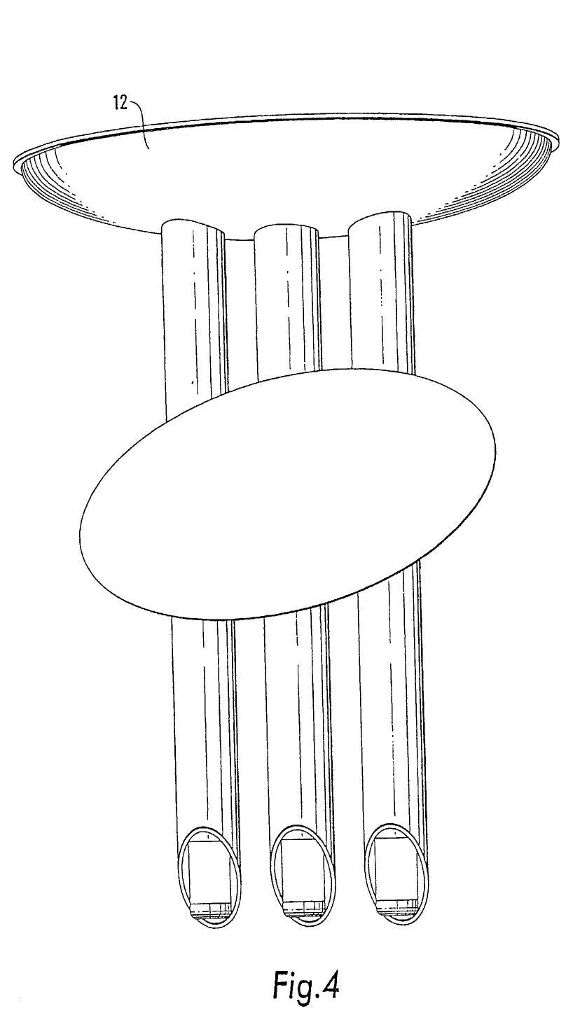

FIG. 4 illustrates an advertising unit according to an embodiment of the invention,

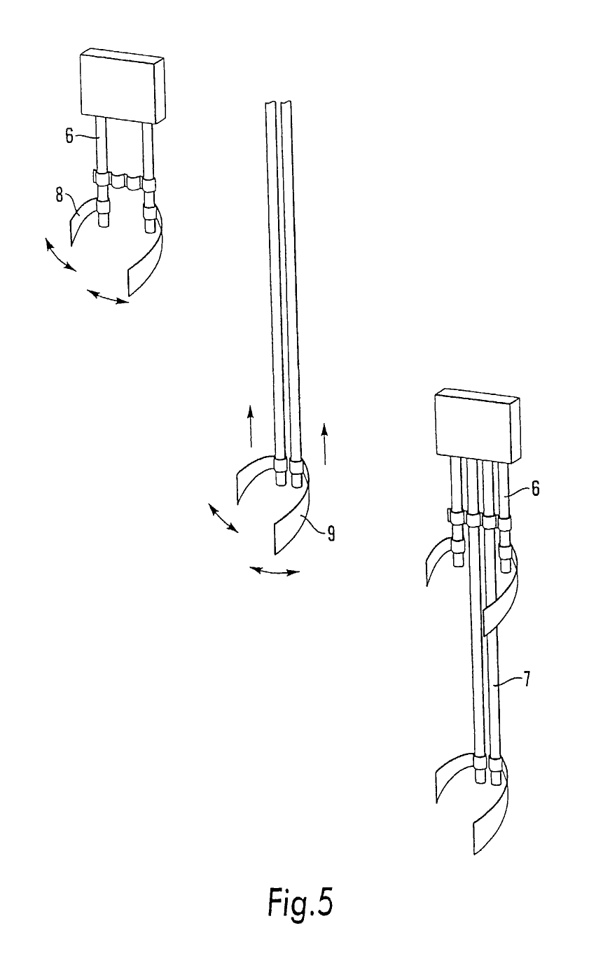

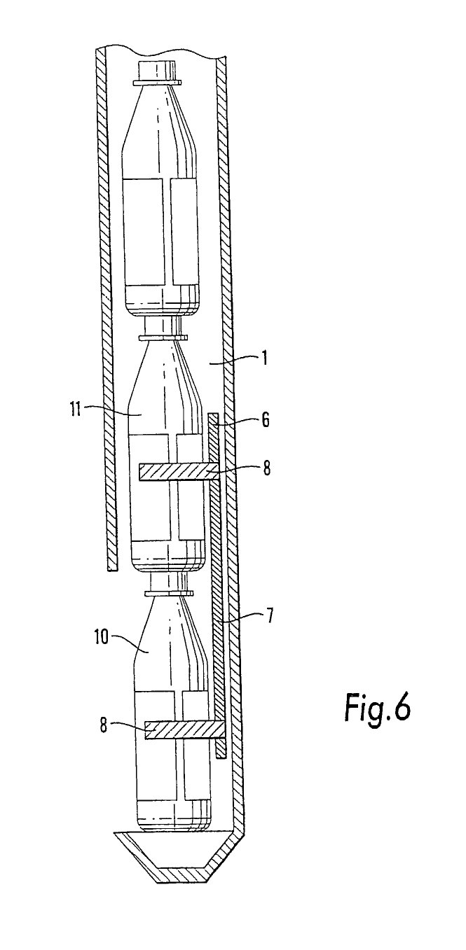

FIGS. 5 and 6 illustrate a holding mechanism for the delivery units.

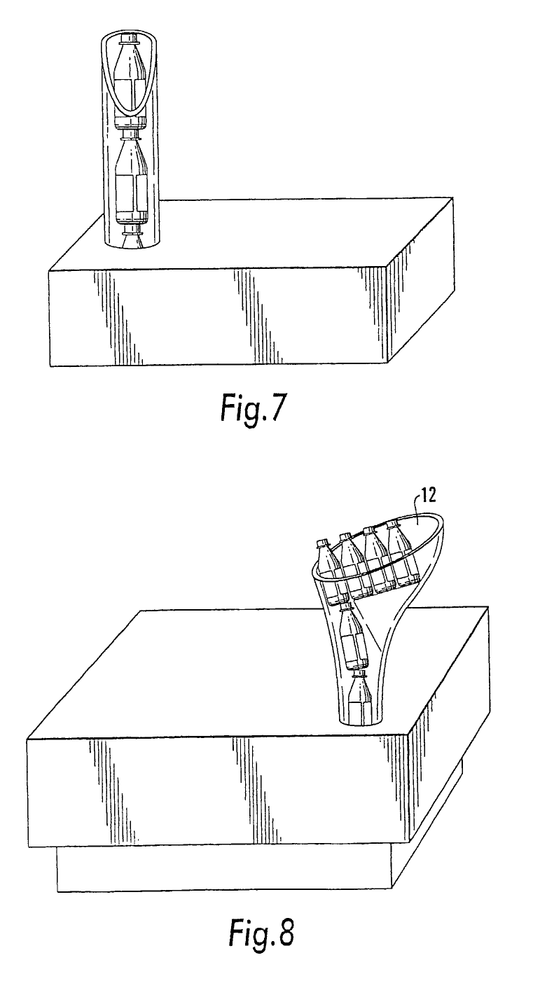

FIGS. 7, 8, 9 and 10 illustrate various embodiments of delivery units.

FIGS. 1 and 2 illustrate a unit according to an embodiment of the invention. The goods are transported through the opening 1, and the cooling/heating/transport fluid can circulate back through the channels 2, while the unit may also comprise a space 3 for insulation, which in a preferred embodiment of the invention is air.

The unit may be equipped with guides 4 for the goods, with ducts 5 for fluid transport or the arrangement of light sources. The light sources may also be provided directly in the guides, as illustrated in detail A.

FIGS. 2 and 3 illustrate the arrangement of several units “in parallel”. In this embodiment of the invention, the opening 1 is a common opening for all units, but individual openings for the units may well be envisaged.

FIG. 4 illustrates an embodiment of the invention where an advertising unit is combined with a delivery unit. The combined unit is equipped with an advertisement holder and the goods are located in such a manner that the labels are as conspicuous as possible. The delivery unit comprises slanting openings in order to make the goods accessible on the side of the transport way where the advertising sign is located.

FIGS. 5 and 6 illustrate a holding mechanism for the push/pull units. The holding mechanism comprises two external bars 6, two internal bars 7, an external set of arms 8 and an internal set of arms 9. The sets of arms can be closed and opened, and they can be moved in the desired direction. When the goods are in the position illustrated in FIG. 6, the item 10 will not be secured by the set of arms 8. When the item 10 is removed from the delivery device, the pair of bars 7 will be moved upwards to take hold of the product 11. The holding mechanism 6, 8 will then release the product which is passed down in a controlled manner.

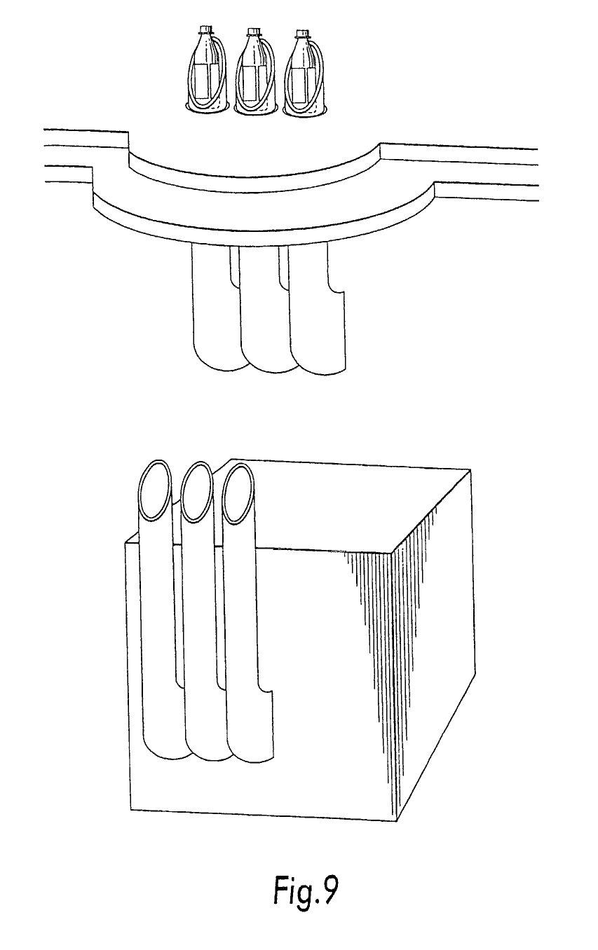

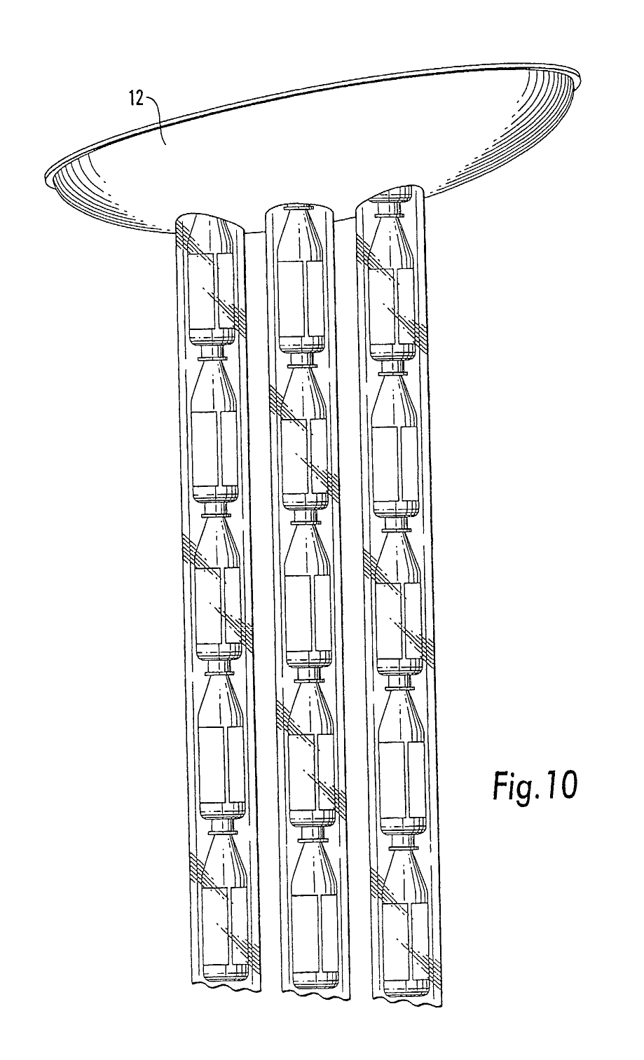

FIGS. 7, 8, 9 and 10 illustrate various embodiments of delivery units. FIG. 7 illustrates a delivery unit combined with an advertising unit, where the delivery unit is transparent. FIG. 8 illustrates a transparent delivery unit which acts as a store 12. FIG. 9 illustrates two further embodiments of the delivery device for use in a system where at least a part of the transport way is provided at ground level. FIG. 10 illustrates an embodiment of the delivery unit where at least a part of the transport way is provided at ceiling level, and where a storage unit 12 is also provided.

The transport system with the discharge and supply devices can be used in several situations where there is a need for flexible storage space, such as, e.g., in dining cars on trains. In this case it will be a very simple matter to convert a carriage into a “dining car”, the main store, e.g., being arranged on the outside of the carriage and the transport system being easily and swiftly installed inside the carriage. The invention also permits an easily used distribution network to be provided for goods to various sales premises for, e.g., major sports arrangements, in which case the store can consist of a container or a lorry and the transport ways can be moved to various sales outlets.

Even though the invention has been described substantially with a view to transport and delivery of chilled/heated goods, it is obvious that the transport of goods at room temperature also lies within the scope of the invention.

1. A transport system for everyday commodities, comprising a supply device which, e.g. is located in a store, a transport device with at least one open or closed transport way and a discharge device which, e.g. is located in sales premises, where the transport way comprises at least one temperature-regulating unit,
characterized in that the temperature-regulating unit is equipped with transport devices for cooling/heating agents, which transport devices are designed in such a manner that the cooling/heating agents and the goods are not in direct contact with one another.

2. A transport system according to claim 1,
characterized in that the temperature-regulating device comprises a support layer for the item, together with one or more additional layers at a distance from the support layer, thus enabling the cooling/heating agents to circulate between the transport way and the additional layer or layers.

3. A transport system according to one of the claims 1-2, characterized in that the cooling/heating agents are cold or hot air.

4. A transport system according to one of the claims 1-3. characterized in that the transport way comprises an internal duct which forms an opening (1) through which the item is transported, an intermediate duct which together with the said internal duct forms a channel (2) through which the cooling/heating fluid can circulate back, and an external duct which together with the said intermediate duct forms a space (3) for insulation, and which is preferably filled with air.

5. A transport system according to one of the claims 1-4, characterized in that in addition it comprises at least one of the following units: advertising units, insulation units, storage units, detector units, pure transport units, push/pull units and delivery units.

6. A transport system according to claim 5, characterized in that it comprises at least one unit which is a combination of advertising units, temperature-regulating units, insulation units, storage units. detector units, pure transport units, push/pull units and delivery units.

7. A transport system according to one of the preceding claims, characterized in that the advertising units are equipped with light sources, including light diodes, and/or advertisement holders, and/or transparent parts, and/or parts equipped with special effects such as, e.g., misting devices, and/or sound effect devices.

8. A transport system according to one of the preceding claims characterized in that the temperature-regulating units are equipped with means for permitting air, water or another fluid to circulate in contact with the goods.

9. A transport system according to one of the preceding claims, characterized in that the insulating units are equipped with thermal or sound insulation.

10. A transport system according to one of the preceding claims, characterized in that the storage units are equipped with heating/cooling devices.

11. A transport system according to one of the preceding claims, characterized in that the detector units comprise means for detecting the presence or passage of the goods and/or smoke, steam and ice detectors or temperature gauges.

12. A transport system according to one of the preceding claims, characterized in that the delivery units comprise a holding mechanism with an external and an internal set of bars, where each set is equipped with arms for securing the item and where the bars permit movement of the arms in a desired direction.

13. A transport system according to one of the preceding claims, characterized in that the delivery units comprise a support surface for the cooling/heating fluid or the transport fluid, and/or a suction hole for the cooling/heating agent, and/or comprise a lid for closing the transport way when it is not in use or is empty.
